(19) United States
(12) Patent Application Publication
(10) Pub. No.: US 2005/0275714 A1
(43) Pub. Date: Dec. 15, 2005

(54) Eyeglass interface device and security system

(75) Inventors: Yohei Ishikawa, Yokohama-shi (JP); Hideo Nishizawa, Tokyo-to (JP); Masafumi Goto, Yokohama-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: MURATA MANUFACTURING CO., LTD.

(21) Appl. No.: 11/144,712

(22) Filed: Jun. 6, 2005

(30) Foreign Application Priority Data
Jun. 9, 2004 (JP) 2004-171009

(51) Int. Cl. H04N 7/14; H04M 11/00

(52) U.S. Cl. 348/14.02; 348/14.01

(57) ABSTRACT

An eyeglass interface device includes a camera section, a wireless communication section, and a power generation section. The camera section acquires the image of the retina of an eyeball of a user, and outputs the imaging signal thereof to the wireless communication section. The wireless communication section transmits the imaging signal from the camera section by a radio wave. The power generation section supplies power to the camera section and the wireless communication section. The eyeglass interface device preferably includes a display section for displaying, on eyeglass lenses, image information sent from a mobile phone or the like to the wireless communication section, and an audio section having a bone conduction earphone and a microphone.

### BACKGROUND OF THE INVENTION

1. Field of the Invention

The present invention relates to an eyeglass interface device that integrates interface elements within an eyewear, and a security system that recognizes the identity of a human using this eyeglass interface device.

2. Description of the Related Art

Recently, security systems are becoming widespread that detect the retina of a person who is attempting to enter/exit the gate of a building, to thereby determine whether the person may proceed in accordance with the retina information.

However, this type of security system is one in which the person attempting to enter/exit the gate presents their eye to a camera provided at the entrance/exit of a building or the like, and after the camera has photographed the retina of the eye, a separate processing device determines the identity between this retina information and retina information that has been registered, to thereby open/close the entrance/exit. The operation of this type of security system, therefore, takes a long time before the person enters/exits the gate.

With this being the situation, an eyeglass interface device has been proposed that is capable of determining the above-described identity by integrating interface elements within an eyewear, and of processing image information of the retina and the like photographed by a camera mounted to an eyewear, using an incorporated computer or the like (see, for example, PCT Japanese Translation Patent Publication No. 2001-522063).

Because the above-described previous art eyeglass interface device is configured to incorporate a high speed computer for processing the image of the retina and the like which is photographed by the camera into the temple of the eyewear or the like, however, the weight of the device itself is high, which may cause discomfort to a user wearing this eyewear. Additionally, the power supply to the computer and the like is constituted by a battery incorporated in the temple tip section or the like, resulting in the time duration of operation of the computer being short, and thereby requiring frequent recharges or battery replacements, resulting in very poor usability.

### SUMMARY OF THE INVENTION

The present invention is directed to solving the above-described problems. Specifically, the present invention is directed to an eyeglass interface device and a security system that are lightweight and easy to use.

According to a first aspect of the present invention, an eyeglass interface device includes: a camera section mounted to a lens frame or a temple of an eyewear, which receives the image of a portion of an eyeball of a user to thereby output an imaging signal thereof; a wireless communication section mounted to a temple tip section or the temple of the eyewear, transmitting the imaging signal from the camera section by a radio wave; and a self-generation type power generation section mounted to any one of the lens frame, the temple, or the temple tip section, supplying power to the camera section and the wireless communication section.

With these features, once the user has worn the eyeglass interface device, the image of one portion of an eyeball of the user is acquired by the camera section, and an imaging signal thereof is outputted. Thereupon, this imaging signal is transmitted from the wireless communication section by a radio wave. Also, the camera section and the wireless communication section are supplied with power by the power generation section.

In the eyeglass interface device according to the present invention, the one portion of the eyeball is preferably the retina or pupil.

With this feature, the retina or pupil of the eyeball is photographed by the camera section, and is wirelessly transmitted as an imaging signal.

In the eyeglass interface device according to the present invention, it is preferable that a display section for displaying various pieces of information inputted from the wireless communication section be provided to at least one of a pair of lenses of the eyeglasses.

With this feature, various pieces of information inputted from the wireless communication section are displayed by the display section provided to at least one of the lenses. Thus the user can view such various pieces of information from the wireless communication section, which provides a great convenience to the user.

In the eyeglass interface device according to the present invention, it is preferable that an audio section including an earphone and a microphone capable of receiving/transmitting sound or the like through the wireless communication section, be provided to the temple tip section or the temple of the eyewear.

With this feature, sound or the like to the earphone in the audio section and sound from the microphone therein are received/transmitted through the wireless communication section. Thus, the user can also obtain information such as sound.

In the eyeglass interface device according to the present invention, the power generation section is preferably a solar battery or a thermo-generator.

With this feature, the need of battery replacement is eliminated, resulting in improved usability. Also, since the power generation section is constituted of a solar battery or a thermo-generator, a more lightweight device can be achieved.

In the eyeglass interface device according to the present invention, the earphone is preferably a bone conduction earphone.

With this feature, the user can obtain information such as sound through the bones instead of the eardrum. By virtue of this feature, even a hearing-impaired user can obtain information such as sound.

In the eyeglass interface device according to the present invention, the wireless communication section is preferably a communication section for performing communications by an ultra wideband (UWB) wireless system.

With this feature, an ultra wideband communication with low noise can be achieved since the wireless communication section performs communications by the UWB system, which is an ultrahigh-speed and close-range wireless system. Thus, since the wireless communication section can perform ultra wideband communications, it becomes possible to exchange a large amount of information with external equipment such as a mobile phone, personal digital assistant (PDA), and notebook personal computer.

According to a second aspect of the present invention, a security system includes the eyeglass interface device as recited above, and a management device. This management device includes a receiving section for receiving the imaging signal transmitted from the wireless communication section of the eyeglass interface device; an image processing section for processing the imaging signal received by the receiving section into image information; and a determination section for determining whether the image information obtained by the image processing section is identical to any one of a plurality of pieces of image information that has been registered.

With these features, the imaging signal transmitted from the user's eyeglass interface device is received by the receiving section of the management device, and then processed by the image processing section into image information. Thereupon, it is determined by the determination section whether the image information obtained by the image processing section is identical to any one of a plurality of pieces of image information that has been registered.

According to the first aspect of the present invention, once the user has worn the eyeglass interface device, the image of one portion of an eyeball of the user is immediately picked up, and therefore it is possible to reduce the time required to recognize the one portion of the eye. Also, the eyeglass interface device according to the first aspect is configured to output the signal from the camera section, as an imaging signal, and transmit it from the wireless communication section by radio wave, without performing complicated image processing with respect to the signal. This eliminates the need to incorporate a high-speed computer or the like for image processing into the device. Hence, the device can be made more lightweight. Furthermore, owing to the computer, which considerably consumes electric power, being unnecessary, the power source can be made to last longer. Moreover, since the power supply to the camera section and the wireless communication section is conducted by the self-generation type power generation section, the present eyeglass interface device can be semipermanently used.

In the security system according to the second aspect, only an imaging signal is generated and transmitted by the eyeglass interface device, while the image information corresponding to this imaging signal is processed on the management device side, and therefore, the overall processing takes only a short time.

Also, by picking up the image of a retina or a pupil having a pattern unique to an individual by the camera section of the eyeglass interface device, it is possible to make a determination of the identity of the image information in the determination section in a very accurate manner.

### BRIEF DESCRIPTION OF THE DRAWINGS

FIG. 1 is a perspective view of an eyeglass interface device according to a first embodiment of the present invention;

FIG. 2 is a schematic plan view showing the construction of the camera section of the eyeglass interface device in FIG. 1;

FIG. 3 is a plan view showing a state where a user wears the eyeglass interface device;

FIG. 4 is a plan view of the main portion of the eyeglass interface device according to a second embodiment of the present invention;

FIG. 5 is a plan view of the main portion of the eyeglass interface device according to a third embodiment of the present invention;

FIG. 6 is a schematic view of a security system according to a fourth embodiment of the present invention; and

FIG. 7 is a block diagram of a management device shown in FIG. 6.

### DESCRIPTION OF THE PREFERRED EMBODIMENTS

Hereinafter, embodiments of the present invention will be described with reference to the accompanying drawings.

### First Embodiment

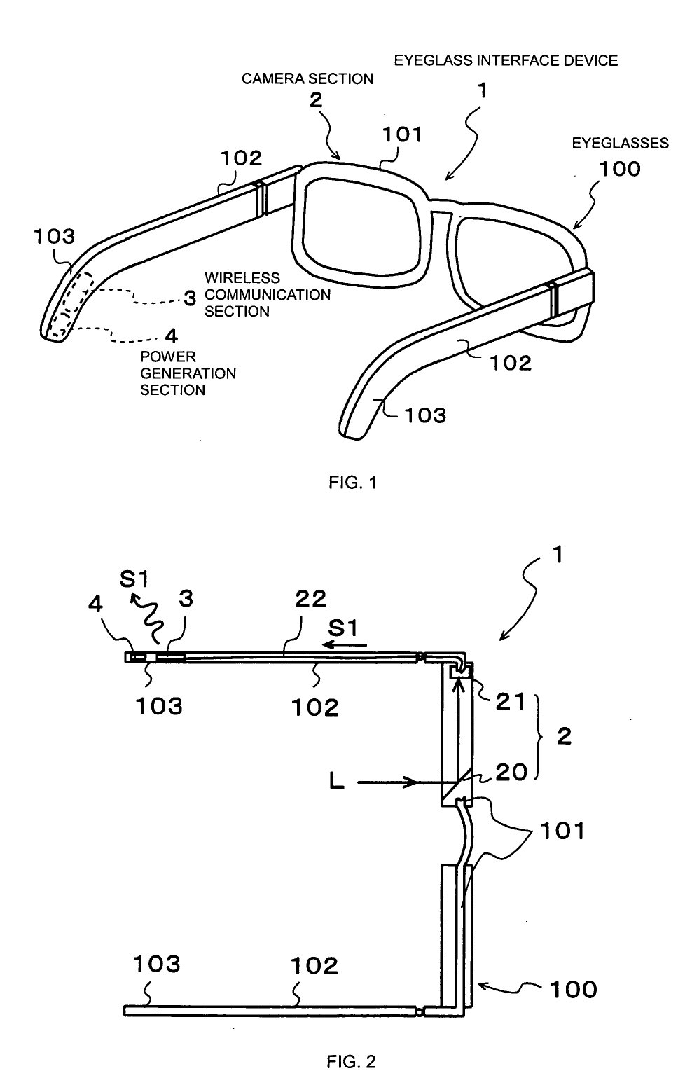

FIG. 1 is a perspective view of an eyeglass interface device according to a first embodiment of the present invention.

This eyeglass interface device 1 is configured to integrate interface elements within eyeglasses 100. Here, the interface elements comprise a camera section 2, a wireless communication section 3, and a power generation section 4.

The camera section 2 is a section for picking up, acquiring, the image of the retina constituting a portion of the user's eyeball, and outputting an imaging signal thereof to the wireless communication section 3.

FIG. 2 is a schematic plan view showing the structure of the camera section 2. As shown in FIG. 2, the camera section 2 is constituted of a mirror 20 and a sensor 21. The mirror 20, with its reflection surface tilted at a predetermined angle toward the user's eyeball (the left side in FIG. 2), is mounted to the inside of the lens frame 101 of the eyeglasses 100. On the other hand, the sensor 21 is formed of a CCD (charge-coupled device) element or the like, and mounted at a lens frame 101 portion close to a corresponding temple 102 so as to face the mirror 20. The output side of the sensor 21 is connected to the wireless communication section 3 via a line 22 passed through the temple 102.

Thereby, light L from the retina in the eyeball of the user wearing the eyeglass interface device 1 is reflected by the mirror 20 toward the sensor 21, and the sensor receives this reflected light L. Then, the sensor 21 converts the received light L into an imaging signal S1 as an electric signal, and outputs it to the wireless communication section 3. While not shown in the figure, a lens can be provided in the sensor 21 so that the focus adjustment can be performed by moving the lens.

The wireless communication section 3 is a section for transmitting the imaging signal S1 from the camera section 2 by a radio wave, and is mounted to a corresponding temple tip portion 103 of the eyeglass interface device 1. This wireless communication section 3 is a communication section performing communications by a well-known UWB wireless system. Hence, it is possible to perform wireless communications taking advantage of a very wide frequency band such as 3.1 GHz to 10.6 GHz.

The power generation section 4 is a section for supplying power to the camera section 2 and the wireless communication section 3, and is mounted to the temple tip portion 103 of the eyeglass interface device 1. This power generation section 4 is a self-generation type battery. In this embodiment, a high visible-light transmittance solar battery is used for the power generation section 4.

Next, descriptions are made of operations and effects of the eyeglass interface device 1 according to this embodiment.

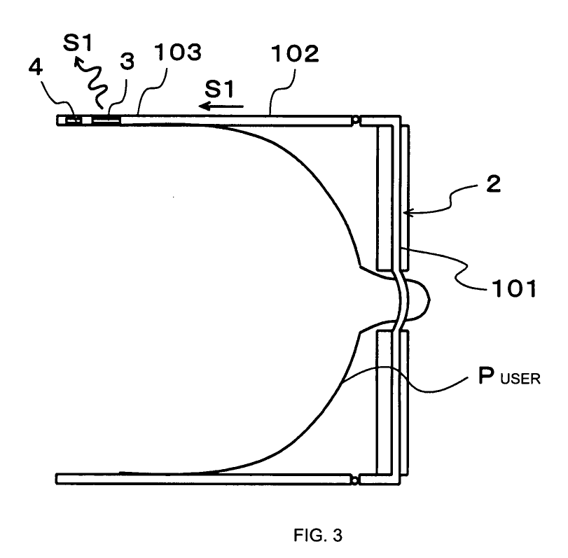

FIG. 3 is a plan view showing a state where a user wears the eyeglass interface device. When the user P has worn the eyeglass interface device 1 as shown in FIG. 3, the light L from a retina of the user P is, as shown in FIG. 2, reflected by the mirror 20 in the camera section 2, and received by the sensor 21. Then, the received light L is converted into an electric signal by the sensor 21, and is outputted to the wireless communication section 3 as an imaging signal S1. Thereupon, the imaging signal S1 is modulated to a radio wave and transmitted from the wireless communication section 3. Since the wireless communication section 3 is capable of wide band wireless communications by the UWB system, the user P can communicate with the user's own external equipment such as mobile phone, PDA, or notebook personal computer. Therefore, the user P can view its own retina information shown by the imaging signal S1 on the display of the mobile phone or the like.

In this manner, once the user P has worn the eyeglass interface device 1, the image of the retina of the user P is immediately picked up in the eyeglass interface device 1, and hence it is possible to reduce the time required for the recognition and processing with respect to the retina in the eyeglass interface device 1.

Also, the eyeglass interface device 1 is configured to transmit the picked-up signal, as an imaging signal S1, from the wireless communication section 3 by a radio wave, without performing image processing with respect to the signal. This eliminates the need to mount a high-speed computer or the like for image processing to the device. Hence, the device can be made more lightweight. Furthermore, the power source can be made to last longer as a computer, which considerably consumes electric power, is not necessary.

Moreover, since the power generation section 4 is a self-generation type battery, the power supply to the camera section 2 and the wireless communication section 3 can be semipermanent. In addition, since the power generation section 4 is a lightweight solar battery, further weight reduction of the eyeglass interface device 1 can be achieved.

### Second Embodiment

Next, a second embodiment of the present invention will be described.

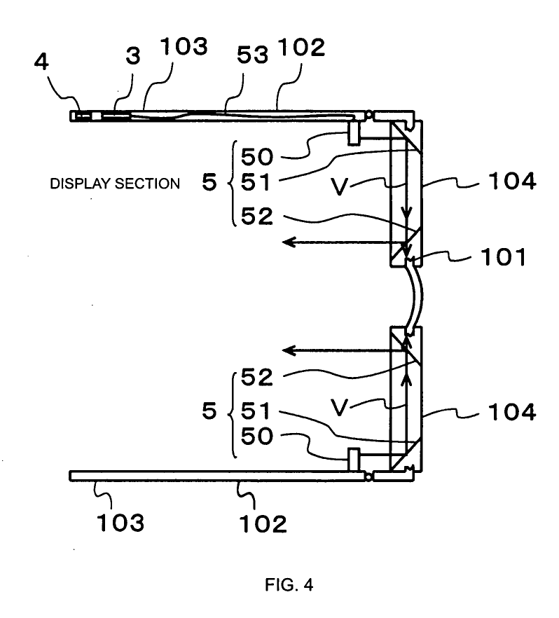

FIG. 4 is a plan view of the main portion of the eyeglass interface device 1 according to the second embodiment of the present invention. As shown in FIG. 4, the eyeglass interface device 1 according to the second embodiment is different from the above-described first embodiment in that it has a display section 5.

Specifically, the eyeglass interface device 1 has a display section 5 provided to each of a pair of lenses 104 of the eyeglasses 100. More specifically, a projection section 50 is provided on each of the temples 102. Also, a mirror 51 with its reflection surface tilted toward the projection section 50 side is provided to each of the lenses 104, as well as a beam splitter 52 is provided to each of the lenses 104 so as to face a respective one of the mirrors 51.

Each of the two projection sections 50 is connected to the wireless communication section 3 through a line 53, whereby various video signals are inputted from the wireless communication section 3 to the projection section 50. As a result, image light V projected from the projection section 50 is reflected by the mirror 51, and thereafter arrives at the user's eyeball through the beam splitter 52.

Since the image information sent from external equipment such as a mobile phone or the like to the wireless communication section 3 is displayed on the lenses 104 by the display section 5, the user P can view the information acquired from the mobile phone or the like while wearing the eyeglass interface device 1 with these features, which affords a great convenience to the user.

The other constructions, operations, and effects are similar to those in the above-described first embodiment, and therefore the descriptions thereof are omitted.

### Third Embodiment

A third embodiment of the present invention will now be described.

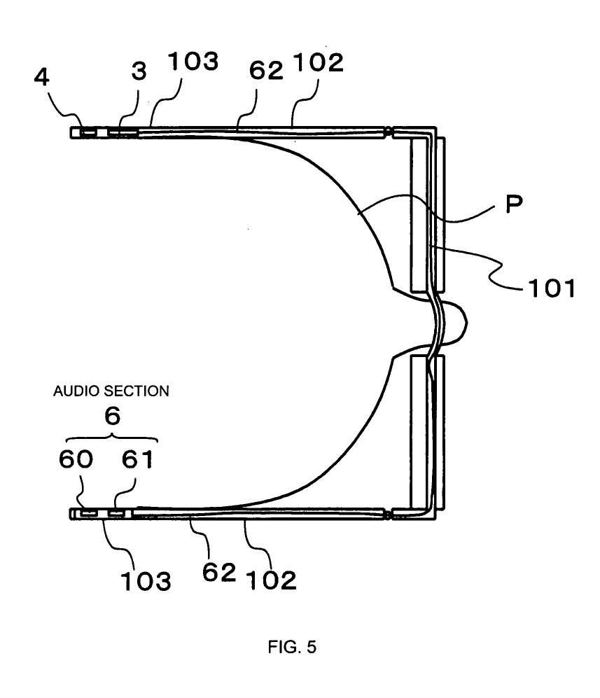

FIG. 5 is a plan view of the main portion of the eyeglass interface device 1 according to the third embodiment of the present invention. As shown in FIG. 5, the eyeglass interface device 1 according to the third embodiment is different from the above-described first and second embodiments in that it has an audio section 6.

According to FIG. 5, the audio section 6 is disposed within one of the temple tip portions 103 of the eyeglasses 100. The audio section 6 constitutes of a bone conduction earphone 60 and a microphone 61, and is connected to the wireless communication section 3 via a line 62 passed through one temple 102, the lens frame 101, and the other temple 102.

Thereby, it is possible to transmit/receive audio information such as sound through the wireless communication section 3. Specifically, audio information sent from external equipment such as a mobile phone or the like to the wireless communication section 3, is transmitted to the bone conduction earphone 60 in the audio section 6, and the user P can listen to this audio information through his/her bones. On the other hand, audio information issued from the user P is captured by the microphone 61 in the audio section 6, and sent to the wireless communication section 3 through the line 62. Thus, this audio information is transmitted from the wireless communication section 3 to the mobile phone or the like.

According to the eyeglass interface device 1 of this embodiment, the user P can obtain information such as sound through its bones instead of its eardrum, and in this way, even a hearing-impaired user can reliably obtain information such as sound.

The other constructions, operations, and effects are similar to those in the above-described first and second embodiments, and therefore the descriptions thereof are omitted.

### Fourth Embodiment

Next, a fourth embodiment according to the present invention will be described.

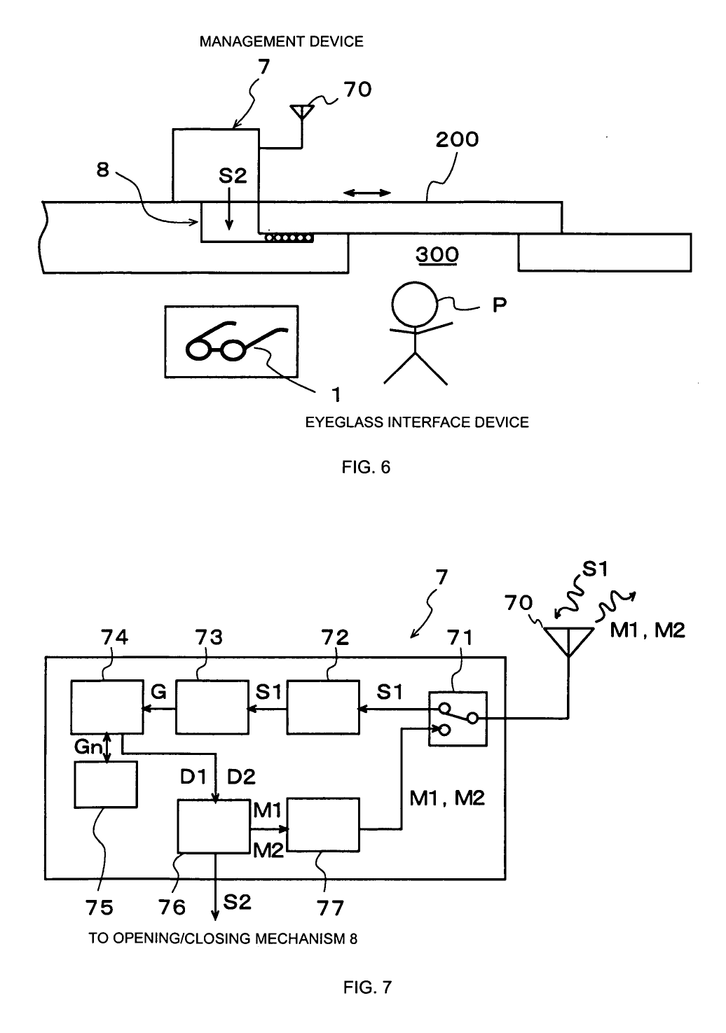

FIG. 6 is a schematic view of a security system according to a fourth embodiment of the present invention, and FIG. 7 is a block diagram of a management device according to this embodiment.

As shown in FIG. 6, the security system according to this embodiment is a system that identifies the identity of a person passing through an entrance/exit gate 200 for opening/closing the entrance/exit 300 of a building, to thereby determine whether the passage of the person is to be permitted.

This security system is constituted of an eyeglass interface device 1 and a management device 7. Here, the eyeglass interface device 1 is the eyeglass interface device 1 according to the above-described third embodiment, and the management device 7 is a device for managing the opening/closing of the entrance/exit gate 200.

The management device 7 is a device capable of outputting, to an opening/closing mechanism 8, a control signal S2 for controlling an opening/closing mechanism 8, the opening/closing mechanism 8 being for mechanically opening/closing the entrance/exit gate 200.

Specifically, as shown in FIG. 7, the management device 7 includes a receiving section 72, an image processing section 73, a determination section 74, registration section 75, a drive section 76, and a transmitting section 77, which are all disposed at the post-stage of a duplexer 71 connected to an antenna 70.

The receiving section 72 is a section that receives an imaging signal S1 sent through the duplexer 71 from the antenna 70, and that, after having demodulated it, transmits it to the image processing section 73. Here, the image processing section 73 is a section that processes the imaging signal S1 from the receiving section 72 into an image information G, and that outputs it to the determination section 74.

The determination section 74 is a section that compares the image information G from the image processing section 73 and a plurality of pieces of image information Gn, and determines whether the image information G is identical to any one of the plurality of pieces of image information Gn. If the image information G is identical to any one of the plurality of pieces of image information Gn, namely, if there is found an image information Gn identical to the image information G in the plurality of pieces of image information Gn, then, the determination section 74 outputs a permission signal D1 to the drive section 76. On the other hand, if there is found no image information Gn identical to the image information G, then, the determination section 74 outputs a non-permission signal D2 to the drive section 76. Here, the drive section 76 is a section that, upon receipt of the permission signal D1 from the determination section 74, outputs a control signal S2 for opening the entrance/exit gate 200 to the opening/closing mechanism 8, and that outputs a message M1 concerning the permission to the transmitting section 77. Conversely, upon receipt of the non-permission signal D2 from the determination section 74, the drive section 76 outputs a control signal S2 for maintaining the closed state of the entrance/exit gate 200 to the opening/closing mechanism 8, and that outputs a message M2 concerning the reason for the non-permission, and the like to the transmitting section 77.

Here, the transmitting section 77 is a section that modulates the messages M1 and M2, and that transmits these to the eyeglass interface device 1 through the duplexer 71 and the antenna 70.

With these features, once the user P has worn the eyeglass interface device 1 shown in FIG. 6, the image of the retina of the person P attempting to enter/exit is picked up by the camera section 2, and the imaging signal S1 thereof is transmitted to the management device 7.

Thereupon, the imaging signal S1 is received by the antenna 70 in the management device 7 shown in FIG. 7, and after having been received by the receiving section 72 through the duplexer 71, it is demodulated. Then, the demodulated imaging signal S1 is converted into an image information G by the image processing section 73, and the image information G is outputted to the determination section 74.

As a result, the image information G on the retina of the person P attempting to enter/exit the gate is compared, by the determination section 74, with a plurality of pieces of image information Gn that has been registered in the registration section 75. If the image information G is identical to any one of the plurality of pieces of image information Gn, namely, if the person P attempting to enter/exit the gate is a person who has registered the retina information thereof into the management device 7, then, a permission signal D1 is outputted from the determination section 74 to the drive section 76. Thereupon, a control signal S2 for opening the entrance/exit gate 200 is outputted from the drive section 76 to the opening/closing mechanism 8, and thereby the entrance/exit gate 200 is opened by the opening/closing mechanism 8. Concurrently with this, a message M1 concerning the permission is outputted to the transmitting section 77, and transmitted to the eyeglass interface device 1 through the antenna 70. This message M1 is received by the wireless communication section 3 of the eyeglass interface device 1, and displayed on the lenses 104 by the display section 5.

Conversely, if the image information G is identical to none of the plurality of pieces of image information Gn, namely, if the person P attempting to enter/exit the gate is a person who has not registered his or her retina information into the management device 7, then, a non-permission signal D2 is outputted from the determination section 74 to the drive section 76. Thereupon, a control signal S2 for maintaining the closed state of the entrance/exit gate 200 is outputted from the drive section 76 to the opening/closing mechanism 8. Thereby, the entrance/exit gate 200 maintains the closed state thereof, and the person P attempting to enter/exit the gate cannot enter the building through the entrance/exit 300. Concurrently with this, a message M2 concerning the reason for the non-permission, and the like is outputted to the transmitting section 77, and transmitted to the eyeglass interface device 1 through the antenna 70. The contents of the message M2 is displayed on the lenses 104 by the display section 5 of the eyeglass interface device 1.

The other constructions, operations, and effects are similar to those in the above-described first to third embodiments, and therefore the descriptions thereof are omitted.

The present invention is not limited to the above-described embodiments, but various modifications and changes are possible within the scope of the inventive concept of the present invention.

For example, in the above-described embodiments, the retina of an eyeball is used as a photographic target of the camera section 2, but a pupil may instead be used as a photographic target.

Also, the above-described embodiments, a lens (not shown) is provided in the pre-stage of the sensor 21 so that the focus adjustment can be performed by moving the lens. Alternatively, however, the focus adjustment may be automatically performed.

Furthermore, a solar battery is used as the power generation section in the above-described embodiments, but a thermo-generator, which generates power by body heat, may be used instead of the solar battery.

Moreover, in the above-described embodiments, a wireless communication section 3 performing communications by the UWB wireless system is used as the wireless communication section, but a wireless communication section that performs communications by an ordinary wireless system may instead be employed.

Additionally, a bone conduction earphone 60 is used as the earphone in the audio section 6 in the above-described third embodiment, but an ordinal earphone used by a hearing person may be employed and the microphone may be omitted.

1. An eyeglass interface device comprising:
an eyewear comprising a lens frame and at least one temple;
a camera section integrated with the eyewear adapted to acquire an image of a portion of an eyeball of a user and output an imaging signal thereof;
a wireless communicator integrated with the eyewear adapted to receive the imaging signal from the camera section and transmit it by radio wave; and
a self-generating power generator integrated with the eyewear and adapted to supply power to the camera section and the wireless communicator.

2. The eyeglass interface device according to claim 1, wherein the camera section is adapted to acquire an image of a portion of a retina or a pupil.

3. The eyeglass interface device according to claim 1, wherein the wireless communicator and power generator are disposed at the temple.

4. The eyeglass interface device according to claim 3, wherein the power generator is a solar battery or a thermo-generator.

5. The eyeglass interface device according to claim 4, wherein the wireless communicator is an ultra wideband wireless communicator.

6. The eyeglass interface device according to claim 5, further comprising a display section integrated with the eyewear adapted to receive information from the wireless communicator and display the information to a position at which it is visible to a wearer of the eyewear.

7. The eyeglass interface device according to claim 6, further comprising an audio section comprising at least one of an earphone and a microphone capable of receiving/transmitting sound from/to the wireless communicator.

8. The eyeglass interface device according to claim 5, further comprising an audio section comprising at least one of an earphone and a microphone capable of receiving/transmitting sound from/to the wireless communicator.

9. The eyeglass interface device according to claim 8, wherein the earphone is a bone conduction earphone.

10. The eyeglass interface device according to claim 1, further comprising a display section integrated with the eyewear adapted to receive information from the wireless communicator and display the information to a position at which it is visible to a wearer of the eyewear.

11. The eyeglass interface device according to claim 1, further comprising an audio section comprising at least one of an earphone and a microphone capable of receiving/transmitting sound from/to the wireless communicator.

12. The eyeglass interface device according to claim 11, wherein the earphone is a bone conduction earphone.

13. The eyeglass interface device according to claim 1, wherein the power generator is a solar battery or a thermo-generator.

14. The eyeglass interface device according to claim 1, wherein the wireless communicator is an ultra wideband wireless communicator.

15. A security system including:
the eyeglass interface device as recited in claim 1, and
a management device, the management device comprising:
a receiver adapted to receive the imaging signal transmitted from the wireless communicator of the eyeglass interface device;
an image processor adapted to convert the imaging signal received by the receiver into image information; and
a determinator adapted to determine whether the image information is identical to any one of a plurality of preexisting pieces of image information.

16. The eyeglass interface device according to claim 15, wherein the power generator is a solar battery or a thermo-generator, the wireless communicator is an ultra wideband wireless communicator, and the camara section comprises a mirror and a light-to-electronic signal converter.

17. A security system including:
the eyeglass interface device as recited in claim 5, and
a management device, the management device comprising:
a receiver adapted to receive the imaging signal transmitted from the wireless communicator of the eyeglass interface device;
an image processor adapted to convert the imaging signal received by the receiver into image information; and
a determinator adapted to determine whether the image information is identical to any one of a plurality of preexisting pieces of image information.

18. A security system including:
the eyeglass interface device as recited in claim 10, and
a management device, the management device comprising:
a receiver adapted to receive the imaging signal transmitted from the wireless communicator of the eyeglass interface device;
an image processor adapted to convert the imaging signal received by the receiver into image information; and
a determinator adapted to determine whether the image information is identical to any one of a plurality of preexisting pieces of image information.

19. A security system including:
the eyeglass interface device as recited in claim 11, and a management device, the management device comprising:
a receiver adapted to receive the imaging signal transmitted from the wireless communicator of the eyeglass interface device;
an image processor adapted to convert the imaging signal received by the receiver into image information; and
a determinator adapted to determine whether the image information is identical to any one of a plurality of preexisting pieces of image information.
